(19) United States
(12) Patent Application Publication
(10) Pub. No.: US 2007/0297768 A1
(43) Pub. Date: Dec. 27, 2007

(54) Interface for recording and editing high definition audio/visual material

(76) Inventor: Johannes M.C.W. de Haas, Breda (NL)

Correspondence Address: MCDERMOTT, WILL & EMERY LLP, 227 WEST MONROE STREET, SUITE 4400, CHICAGO, IL, 60606-5096, US

(21) Appl. No.: 11/788,567

(22) Filed: Apr. 20, 2007

(30) Foreign Application Priority Data
Apr. 21, 2006 (EP) 06075934.7

(51) Int. Cl. H04N 5/91

(52) U.S. Cl. 386/104; 386/E05.001

(57) ABSTRACT

The invention relates to a compact and mobile recording and editing interface for image and sound material in preferably uncompressed form with a suitable camera with a resolution standard 3K/800 Mb/s; 50 p/fps or 4:4:4, in which the necessary components of the interface are accommodated in a suitable box with swiveling castors and handgrips, so that on location quickly and efficiently image and sound material can be recorded and, if necessary, edited directly, which considerably decreases the production costs for image and sound material.

### TECHNICAL FIELD

The present subject matter relates to an interface for processing, saving and editing HD-image and sound material. More specifically, the present subject matter relates to an interface directly coupled to a camera with accessories for recording image and sound according to the resolution standard 3K/800 Mb/s; 50 p/fps; HD 4:4:4 and possibly HD 4:2:2, in which working with uncompressed HD image and sound material is most suitable for obtaining an end product of the highest quality.

### BACKGROUND

In practice, the demands on recording and editing image and sound material are increasingly higher. Especially regarding improving the efficiency of producing quality audio/visual material.

In order to gain time, one should have possibilities for editing, color corrections and such on location.

U.S. patent application Ser. No. 11/284,007, filed on Nov. 21, 2005 titled “Method For Manufacturing Audio Visual Productions,” the entirety of which is incorporated herein, describes how image and sound material from a recording camera, recorded according to the resolution standard HD 4:4:4, is directly processed to the required audio visual product by means of a interface connected to a HD editing machine. The whole of cameras, HD-editing machine and such is placed in a company vehicle, the size of an average transporter.

Using the teachings of the referenced patent application, on a recording location, cameras can be connected to the HD-editing machines using long cables. However, the system and method disclosed in the referenced patent application is still extensive. Therefore, there may be advantages to providing a system that is more compact and mobile so that, for example, no streets and such have to be closed off during recording, and further to record suitable image and sound material quickly and also to edit the material directly, to acquire suitable image and sound material for the client within very little time.

Therefore, the need exists for a compact interface with which one can work quickly and with flexibly on location.

### SUMMARY

The above and other needs are met by the disclosed embodiments which provide an interface constructed as a completely integrated processing and editing unit for image and sound material recorded with a camera coupled thereto. The interface, placed in a box, consists of the following components:

a two-cabled 3KS/800 Mb/s; 50 p/fps; 4:4:4 or 4:2:2 Dual Link System with an SCSI cable junction connected with:

a RAID Storage system consisting of a number of hard disks;

an LTC or VIT RS422 generator for eliminating time differences between image and sound;

a PC or CPU with monitor with extra RAID control cards and editing software for editing effects and exporting image and sound material.

The advantage is, that the interface is placed in a box in a well-organized manner, with all the necessary components, which especially improves the work efficiency on location considerably.

Further, the interface is accommodated in a 19 inch rack and placed in a handy standard 19 inch box for computers, in which said box is provided with swiveling castors and handgrips.

The advantage is that common standard boxes for computers can be used to completely accommodate the interface.

Furthermore, the interface is suited for use with a camera with a resolution standard of 3K/800 Mb/s; 50 p/fps or HD 4:4:4, for example a Grass Valley Viper camera or an ARRI D20 camera.

The advantage is that, after testing several cameras, a camera with the characteristics of the Grass Valley Viper camera was most suitable for the present recording system. The ARRI D20 also belongs to the mentioned range of cameras.

### BRIEF DESCRIPTION OF THE DRAWINGS

The preferred construction of the invention will be described by way of example, and with reference to the accompanying drawing.

In which:

FIG. 1 shows a schematic arrangement of the components of the interface coupled to a suitable camera according to the present invention;

FIG. 2 shows a further elaboration and arrangement of the components of the interface; and

FIG. 3 shows an easily moveable box housing the interface.

### DETAILED DESCRIPTION OF THE PREFERRED EMBODIMENTS

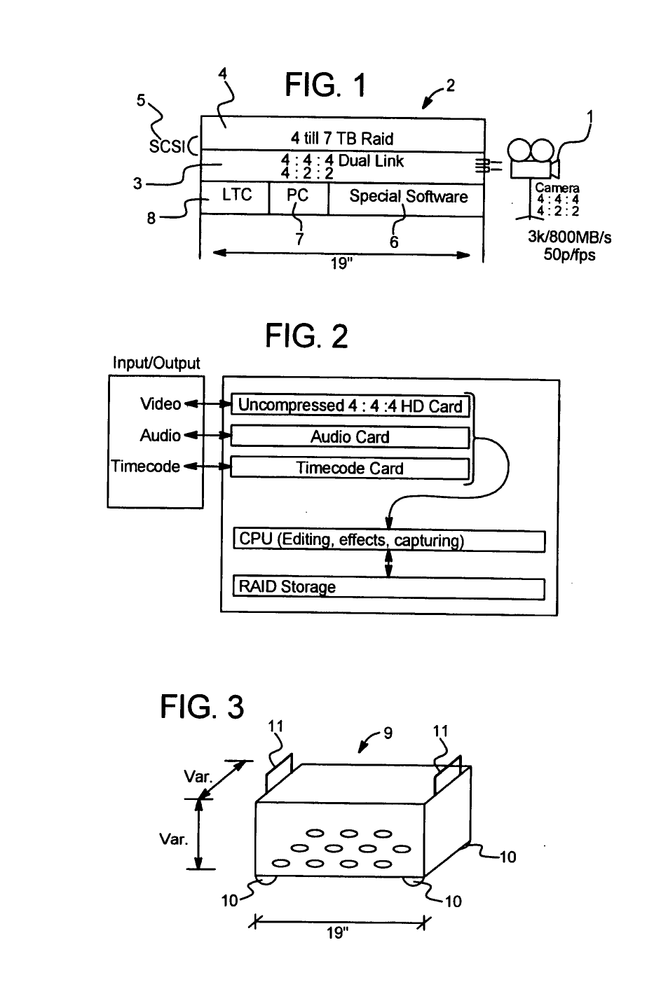

FIG. 1 shows a schematic arrangement of the components of an interface 2 connected to a camera 1 with a resolution standard of 3K/800 Mb/s; 50 p/fps; 4:4:4 or possibly 4:2:2. The image and sound material, the so called workflow, is delivered from the camera 1 to the interface 2 through two cables connecting camera 1 to the interface 2. The workflow is received by a 3K/800 Mb/s; 50 p/fps; 4:4:4 or 4:2:2 Dual Link system 3. The Dual Link system 3 is connected to a RAID system 4 having a storage capacity of approximately 4-7 terabytes. As shown in FIG. 1, the Dual Link system 3 is connected to the RAID system 4 using a SCSI cable 5. The SCSI cable 5 is a universal cable for very large data transports. The 4-7 terabyte RAID system 4 shown in FIG. 1 is constructed of a number of hard disks.

From the RAID system 4 the user (operator) can adjust the interface 2 in such a way that the image and sound material is shown on a (not indicated) monitor and with that can be edited, as described in U.S. patent application Ser. No. 11/284,007, filed on Nov. 21, 2005 titled “Method For Manufacturing Audio Visual Productions,” the entirety of which is incorporated herein.

Editing the image and sound material can be done by applying effects or changing backgrounds with special software 6, such as, for example, editing software that runs on Windows and, for example, includes the programs Premiere, Final CUT-Pro and AVID. The special software 6 works, for example, with Windows on a personal computer (“PC”) 7. With a latent time code generator 8, such as, for example a VIT RS422, the time differences between image and sound can be eliminated.

As shown in FIG. 3, the interface 2 is placed in a box 9 with a standard length of 19 inches. On location, the box 9 can be moved using swiveling castors 10 and can easily be handled with handgrips 11.

FIG. 2 shows a further arrangement of the afore described preferred components, by which the scheme does not need further explanation.

Finally it has to be emphasized, that the above description constitutes a preferred embodiment of the invention, but that obviously further modifications are possible without departing the scope of this patent description.

1-6. (canceled)

7. An system for processing, saving and editing high definition image and sound material comprising:
a camera with accessories for recording image and sound according to the resolution standard 3K/800 Mb/s; 50 p/fps; HD 4:4:4 or HD 4:2:2; and
an integrated processing and editing interface for the recorded image and sound material coupled to the camera and placed in a housing, wherein the interface includes:
a two-cabled 3K/800 Mb/s; 50 p/fps; 4:4:4 or 4:2:2 Dual Link system;
a RAID storage system consisting of a plurality of hard disks connected to the Dual Link system using a SCSI connection;
an linear time code generator for eliminating time differences between image and sound; and
a PC or CPU and monitor with extra RAID Control cards and editing software for editing effects and exporting image and sound material.

8. The system of claim 7, wherein the interface is accommodated in a 19 inch rack and placed in a standard 19 inch box for computers, in which the box is provided with swiveling castors and handgrips.

9. The system of claim 7, wherein the camera is the camera sold by Grass Valley under the trademark Viper FilmStream.

10. The system of claim 7, wherein the camera is the camera sold by the ARRI Group under the trademark ARRIFLEX D-20.

11. The system of claim 7, wherein the RAID storage has a total capacity of approximately 4-7 terabytes.

12. The system of claim 7, wherein the editing software is the editing software sold by Adobe Systems Inc. under the trademark Premiere, the editing software sold by Apple, Inc. under the trademark Final CUT-Pro or the editing software sold by Avid Technology, Inc. under the trademark AVID.
